(19) United States
(12) Patent Application Publication
(10) Pub. No.: US 2008/0189180 A1
(43) Pub. Date: Aug. 7, 2008

(54) UTILITY RESOURCE CONSERVATION METHOD

(76) Inventors: Lee J. Maher, Orlando, FL (US); Zach Steele, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/953,152

(22) Filed: Dec. 10, 2007

Related U.S. Application Data
(60) Provisional application No. 60/869,185, filed on Dec. 8, 2006.

(51) Int. Cl. G06Q 10/00

(52) U.S. Cl. 705/14

(57) ABSTRACT

A utility resource conservation method may include determining a periodic consumption value for at least one utility resource by a utility consumer without use of at least one utility resource conservation device, and determining a periodic payment amount for the utility consumer with use of the at least one utility resource conservation device by applying a discount to the periodic consumption value so that the periodic payment amount is less than the periodic consumption value. The method may further include installing the at least one conservation device to reduce consumption of the at least one utility resource by the utility consumer. The periodic payment amount may advantageously include payment for the reduced consumption of the at least one utility resource, and for the at least one utility resource conservation device.

### CROSS-REFERENCE TO RELATED APPLICATIONS

This application claims the benefit of U.S. Provisional Application Ser. No. 60/869,185, filed on Dec. 8, 2006, the contents of which are herein incorporated by reference in their entirety.

### FIELD OF THE INVENTION

The present invention relates to a resource conservation method, and, more particularly, to systems and methods for reducing consumption of utility resources.

### BACKGROUND OF THE INVENTION

With the ever-increasing costs of utilities resulting from the rise in fossil fuel prices, alternative utility producing systems are becoming more desirable. Moreover, the need for such alternative systems is also being driven by pollution and greenhouse gas emission standards and an environmentally conscious consuming public. Therefore, many consumers have a high degree of interest in utility systems that are less dependent upon purchased electricity or fuels, and/or are more “green.” By way of example, such utility systems may include electrical power generating systems and air/water heating systems.

Yet, a significant obstacle to implementing more energy efficient or green utility systems, such as solar or wind powered electrical generators, solar water heaters, etc., is the significant up front cost (i.e., initial investment) required to purchase and install such systems. Various approaches have been developed for dealing with this problem. By way of example, Japanese Published Patent Application No. 2003-308464 to Kobayashi discloses a solar water heating rental system that requires no initial investment by a user. The solar water heater is installed in a user's house by an initial investment supply/maintenance or lease trader (i.e., service provider) with no up-front cost to the user. The user simply pays a monthly service charge corresponding to a frequency of use of the heater. The frequency of use is determined using a calorimeter, flow meters, and temperature sensors that determine the 4 contribution of the solar heater in producing the overall amount of hot water consumed by the user.

U.S. Published Patent Application No. 2002/0040356 to Gluck et al. is directed to an automated new energy technology consulting and demand system and related methods. This system may pertain to photovoltaic (PV) or wind turbine energy sources, for example. Gluck et al. also discusses various financing approaches for new energy systems.

A method for financing a renewable energy generating facility, such as a wind or solar power energy facility, is disclosed in U.S. Published Patent Application No. 2002/0194145 to Boucher et al. In this approach, a developer builds the facility, and in consideration for a specified payment the developer sells or transfers to an “actor” the present ownership of some or all right, title, or interest in and to energy attributes (e.g., government “green” credits) associated with the energy generated by the facility over its operational life. The energy attributes are “severed” from the energy that generates them by selling or otherwise transferring such energy, e.g., to a pool, in transactions in which the source of the energy is not disclosed to the transferee (i.e., consumer), or in which the transferee is put on notice that it is acquiring legal ownership of only the generic energy commodity, and has no rights to the energy attributes. Once severed, the energy attributes can be traded as a commodity by the actor separately from the energy that generated them.

Despite such approaches, additional arrangements for providing utility resource conservation systems to consumers may be desirable to lessen the up front costs and risks taken by the consumers.

### SUMMARY OF THE INVENTION

According to an embodiment of the present invention, a utility resource conservation method may include comprises determining a periodic consumption value for at least one utility resource by a utility consumer without use of at least one utility resource conservation device, and determining a periodic payment amount for the utility consumer with use of the at least one utility resource conservation device by applying a discount to the periodic consumption value so that the periodic payment amount is less than the periodic consumption value. The method may further include installing the at least one conservation device to reduce consumption of the at least one utility resource by the utility consumer. The periodic payment amount may advantageously include payment for the reduced consumption of the at least one utility resource and for the at least one utility resource conservation device.

According to an aspect of the present invention, the method may further include determining an expected utility resource savings from use of the at least one utility resource conservation device, and determining the discount based on the expected utility resource savings. According to another aspect of the present invention, the at least one conservation device may be at least one utility resource replacement device.

### BRIEF DESCRIPTION OF THE DRAWINGS

FIG. 1 is a schematic block diagram of a utility resource consumer without utility resource conservation devices;

FIG. 2 is a schematic block diagram of the utility resource consumer system of FIG. 1, with a plurality of utility resource conservation devices added thereto;

FIG. 3 is an organizational view of the relationship between the utility resource consumer of FIG. 1 and a utility resource conservation agent according to an embodiment of the present invention;

FIG. 4 is a flowchart of a utility resource conservation method according to an aspect of the present invention;

FIG. 5 is a flowchart detailing part of the method of FIG. 4; and

FIG. 6 is a flowchart detailing another part of the method of FIG. 4.

### DETAILED DESCRIPTION OF A PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

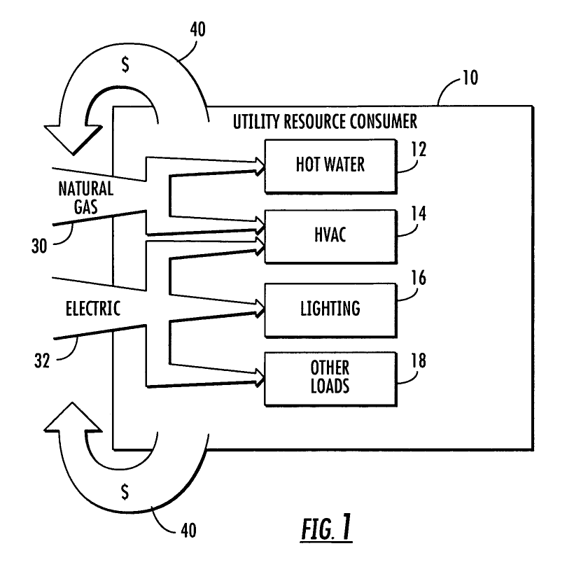

Referring to FIG. 1, a utility resource consumer 10, such as a hotel or resort facility, utilizes a plurality of utility resource consumption devices 12-18. The utility resource consumption devices 12-18 illustratively include a hot water heating system 12, a heating, ventilation and air conditioning (HVAC) system 14, a lighting system 16, and other loads 18, such as a laundry, kitchen, elevators, pool equipment, etc. Usage of the utility resource consumption devices 12-18 consumes a plurality of utility resources 30, 32, including natural gas 30 and electric 32. On a periodic basis, the utility resource consumer would ordinarily make payments 40 to one or more utility companies in exchange for the utility resource 30, 32 consumption

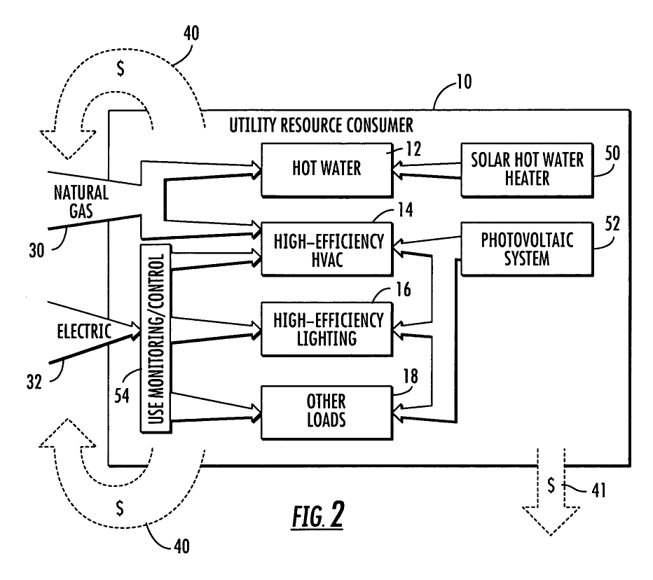

Referring to FIG. 2, one or more of a plurality of utility resource conservation devices 14′, 16′ and/or 50′-54′ are installed to reduce utility resource 30′, 32′ consumption. The utility resource conservation devices include utility resource replacement devices 50′, 52′ and utility resource reduction devices 14′, 16′ and 58. The utility resource replacement devices 50′, 52′ are, respectively, a solar hot water heater and photovoltaic system. The utility resource replacement devices 50′, 52′ operate to supply a corresponding resource to applicable utility resource consumption devices 12′-18′, at least partially replacing the previously supplied utility resource 30′, 32′ required for operation thereof.

The utility resource reduction devices 14′, 16′ and 54′ include a high-efficiency HVAC system 14′, such as a system with better insulated ducting, a high-efficiency lighting system 16′, such as a system including fluorescent lighting, and a utility use monitoring and control system 58′. The high-efficiency systems 14′, 16′ have increased efficiency relative to the previously installed systems 14, 16. The systems 14′, 16′ require less energy to accomplish the same amount of work and reduce the consumption of the corresponding utility resource 30′, 32′, as will be appreciated by those skilled in the art.

The utility use monitoring and control system 54′ can include load controllers, motion detectors and automatic shut-off devices, consumption monitoring devices and the like for more efficiently operating utility resource consumption devices and securing use of utility resource consumption devices when not needed, to reduce the utility resource 30′, 32′ consumption. The utility use monitoring and control system 54′ can also include consumption monitoring devices and the like for quickly identifying problems, such as unusually high utility resource consumption by utility resource consumption devices, so that the problem can be corrected before leading to excess utility resource 30′, 32′ consumption.

It will be appreciated that installation of the utility resource conservation devices 14′, 16′ and 50′-54′ potentially involves a substantial expense to the utility resource consumer, typically requiring some type of financing to cover the costs of the devices 14′, 16′ and/or 50′-54′. The utility resource consumer is then faced with paying the utility payments 40, in addition to a financing payment 41′.

Depending on factors like the terms of the financing and the actual utility resource consumption reduction achieved, the utility resource consumer may initially face a total payment amount that is much higher than what the total of the utility payments 40′ without the utility resource conservation devices 14′, 16′ and/or 50′-54′. Since the utility resource consumer may be poorly equipped to evaluate these factors, a higher total payment amount is a real risk. Due to this risk and the relatively narrow profit margins of many utility resource consumers, the long term savings to the utility resource consumer and benefit to the environment may not be realized.

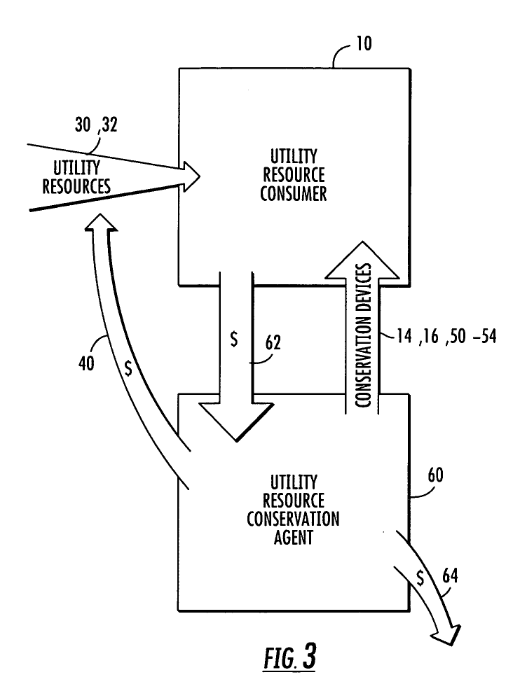

Referring to FIG. 3, to minimize the risk to the utility resource consumer and realize the potential savings and environmental benefits, a utility resource conservation agent 60″ installs the utility resource conservation devices 14′, 16′ and/or 50′-54′ (see FIG. 2) for the utility resource consumer. For example, the utility resource conservation agent 60 could arrange to have one or more contractors install the utility resource conservation devices 14″, 16″ and 50″-54″, in exchange for a periodic payment amount 62″ determined by the utility resource conservation agent 60″.

The periodic payment amount 62″ covers both payment 40″ for the reduced consumption of the utility resources 30″, 32″ and payment for use of the utility resource conservation devices 14″, 16″ and 50″-54″. Advantageously, the periodic payment amount 62″ is less than what would be otherwise paid for the utilities 30″, 32″ without the devices 14″, 16″ and 50″-54″. The utility resource conservation agent 60″ then makes payment 40″ for the utility resources 30″, 32″ and payment 64″ for costs and overhead, including, for example, salaries and debt service on any financing obtained to fund the installation of the utility resource conservation devices 14″, 16″ and 50″-54″.

It will be appreciated that the appropriate determination of the periodic payment amount 62″ by the utility conservation agent 60″ advantageously enhances the economic viability of the installation of the utility resource conservation devices 14″, 16″ and/or 50″-54″, making the realization of utility resource conservation by the installation of utility resource conservation devices and corresponding benefit to the environment more readily achieved.

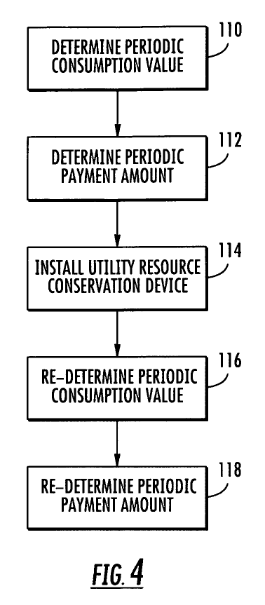

Referring to FIGS. 3 and 4, a utility resource conservation method 100 associated with such a determination will now be described. At block 110, a periodic consumption value is determined, The periodic consumption value accounts for the value of utility resources used by the utility consumer without the use of the utility resource conservation devices. At block 112, the periodic payment amount 62 is determined for the utility resource consumer with use of the utility resource conservation devices. At block 114, the utility resource conservation devices are installed. After a predetermined number of payments, the periodic consumption value and periodic payment amount (initially determined in blocks 110 and 112, respectively) may be re-determined at blocks 116 and 118, respectively. For example, this may be done to adjust for increasing utility costs or usage by the consumer, as will be further discussed below.

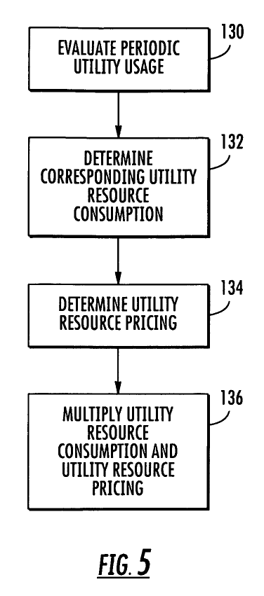

Referring to FIG. 5, the determination of the periodic consumption value illustrated at Block 110 will be further described. At blocks 130 and 132, periodic utility usage by the utility resource consumer is evaluated, and a corresponding consumption of utility resources is determined. For the initial determination of consumption, evaluation may be accomplished, for instance, by reviewing utility bills over the previous year or more and obtaining a monthly average for use. For example, the utility resource consumer is determined to consume 500 cubic feet of natural gas, and 500 kilowatt-hours of electricity each month.

At block 134, the utility resource pricing is determined, for instance, by examining the utility bills to determine the current rates the utility resource consumer is being charged for the utility resource consumption, including any applicable taxes and other charges. At block 136, the utility resource consumption (from block 132) is multiplied by the pricing (from block 134) to determine the periodic consumption value for the utility resources. For example, natural gas 30 may be priced at $1 per cubic foot and electric 32 may be priced at $1 per kilowatt-hour, resulting in a monthly consumption value of $1000 for natural gas 30 and electric 32.

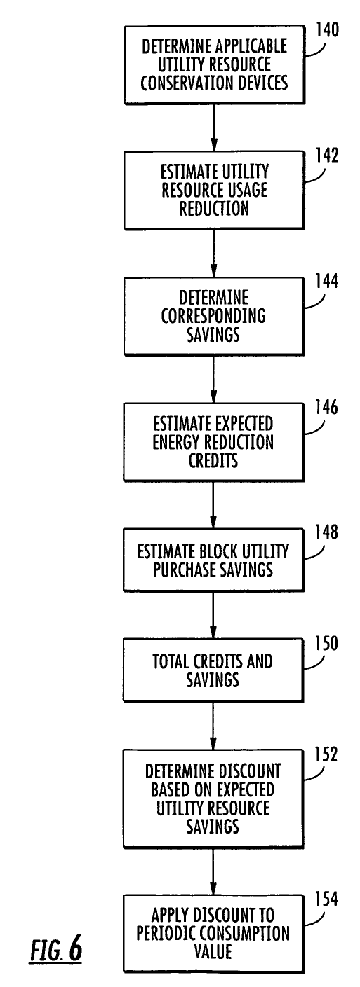

Referring to FIG. 6, the determination of the periodic payment amount illustrated at Block 112 will be further described. At block 140, applicable utility resource conservation devices are determined. For example, for the utility consumer, applicable utility resource conservation devices include the high-efficiency HVAC and lighting 14′ and 16′, the solar hot water heater 50′, the photovoltaic system 52′, and/or the utility use monitoring and control system 54′.

At block 142, the utility resource usage reduction achievable by the utility resource conservation devices is estimated. For example, installing the utility resource conservation devices 14′, 16′ and/or 50′-54′ might be estimated to reduce both natural gas and electric usage by 50%. At block 144, the savings corresponding to such a usage reduction are determined. Based on the utility rates applied at block 136, the savings based directly on utility resource usage reduction would equal 50% of $1000, or a $500 savings.

At block 146, any expected energy reduction credits are estimated. Such credits can include, for example, money rebated or granted by governmental or non-governmental agencies for energy usage reductions that achieve a certain threshold, as well as credits for installing particular utility resource conservation devices. For purposes of the present example, it will be assumed that such credits amount to $50 a month averaged on a monthly basis.

At block 148, block utility purchase savings may be estimated. For example, the utility resource conservation agent may serve a plurality of utility resource consumers and is able to effectively bargain to make block purchases of utilities at lower rates than would otherwise be available to a given utility resource consumer 10. For the present example, it will be assumed that such savings amount to, averaged on a monthly basis, another $50 per month.

To determine the expected utility resource savings, at block 150, the credits and savings estimated at blocks 144-148 are totaled. In this example, the expected utility resource savings equal an average of $600 a month, or 60% less than the average of $1000 a month periodic consumption value determined at block 110. At block 152, a discount is determined based on the expected utility resource savings. For example, 25% of the savings could be passed to the utility resource consumer 10, resulting in a $150 per month discount.

At block 154, the discount is applied to the periodic consumption value determined in block 110 to determine the periodic payment amount 62. In the current example, the periodic payment amount 62 would equal the $1000 periodic consumption value minus the $150 discount, or $850 a month. In some embodiments, the discount may be changed (i.e., increased) after a predetermined period. For example, after 24 months of payments, the discount may be increased to 50% of the expected utility resource savings. In the current example, this would result in a $300 per month discount and a periodic payment amount of $700 per month.

It will be appreciated that the present invention allows the utility resource consumer to obtain benefits of utility resource conservation devices for little or no upfront cost and for a periodic payment amount that is less than what was previously paid for the utility resources 30, 32 by themselves. Utility resource consumers will thereby advantageously be encouraged to have utility conservation devices installed who would otherwise have been prevented by the economic risks/costs associated therewith. The financial risks associated with estimating utility resource reduction savings are assumed by the utility resource conservation agent, who is typically better equipped to make accurate estimations.

The utility resource conservation agent 60″ retains the difference between the reduced utility payments 40″ and the periodic payment amount 62″. If the expected utility resource savings determined at block 152 are accurate, then, in the current example, the utility resource conservation agent 60 retains $450 in an average month, or $300 in an average month after the increase in the discount to 50% (i.e., after the first 24 months). These amounts also include the energy reduction credits and block utility purchase savings. This amount is used for the payment 64″ of the costs and overhead. Any further amount remaining is the profit for the utility resource conservation agent 60″.

Even the utility resource conservation agent 60″ accurately estimates the expected utility resource savings initially, profits may still be reduced or eliminated by changes in a plurality of factors, some of which may result in a “windfall” for the utility resource consumer 10. These factors include, for instance, an increase in rates for utilities 30, 32 or an increase in utility resource consumption by the utility resource consumer 10, such as due to business growth. In the current example, if rates for the utilities 30, 32 were to double, then the corresponding savings would be reduced by half, or to an average of $250 per month. Such a change would reduce the amount retained by the utility resource conservation agent 60 to $200 per month, or just $50 per month after the increase in the discount.

Referring again to FIG. 4, such a risk is addressed by the re-determination operations illustrated in blocks 116 and 118. These re-determinations are essentially the same as the initial determination operations illustrated in blocks 110 and 112, respectively, as shown in FIGS. 5 and 6. However, to accurately re-determine periodic utility resource consumption without the utility resource conservation device, the energy or other utility supplied by the utility resource replacement devices 50, 52 are equated to a corresponding level or utility resource consumption that would be occurring in the absence of such devices. Likewise, the savings attributable to the utility resource reduction devices 14″, 16″ and/or 50″-52″ are also cancelled out.

In the current example, the increase in utility 30, 32 rates would result in a re-determined periodic consumption value of $2000 per month. The utility resource conservation devices 14″, 16″ and/or 50″-54″ are estimated to reduce such consumption by 50%, resulting in a corresponding savings of $1000 per month. If the expected energy reduction credits and block utility purchase savings remain the same then the expected utility resource savings now equal $1100 per month, on average. This results in a $275 discount at the 25% savings rate, or a $550 discountat the 50% savings rate. Correspondingly, the periodic payment amount 62 is increased to $1725 per month at a 25% discount, or $1450 per month at a 50% discount.

While the re-determined periodic payment amount 62″ is higher than the original periodic payment amount, the new periodic payment amount is still lower than what the utility resource consumer would otherwise be paying for resources 30, 32 without the utility resource conservation devices (i.e., $2000). In other words, the utility resource consumer is still better off, and the prospect of a re-determination should not deter the utility resource consumer from acquiring the utility resource conservation devices.

Those skilled in the art will appreciated that the present invention is not necessarily limited to the embodiments herein shown and described, but that various modifications and adaptations to particular circumstances are possible within the scope of the present invention. For instance, the utility resource consumer 10 is not limited to a hotel or resort. Examples of other utility resource consumers include manufacturing plants, retail outlets and residences. The utility resource consumption devices 12-18 are not limited to the number or type of devices shown. For example, other utility resource consumption devices may include manufacturing equipment and refrigeration equipment may be found.

Also, the utility resource consumption devices 12-18 are not limited to consumption of a particular utility resource. Additionally, the invention is not necessarily limited to particular utility resources. For example, the hot water system 12 could consume electricity or oil rather than, or in addition to, natural gas. Also, other resources, such as water could be considered as a utility resource in the context of the present invention. In such an embodiment, the accompanying utility resource (i.e., water) conservation device may include low-flow shower nozzles, toilets, ets., as will be appreciated by those skilled in the art.

Additionally, the present invention is not necessarily limited to a particular type or combination of utility resource conservation devices. For example, a wind turbine(s) could be employed as a utility resource replacement device to replace some of the electric supply 32. A water saving device(s) could be employed as a utility resource reduction device to reduce the consumption of water, as noted above.

Furthermore, the present invention is not necessarily limited to an arrangement wherein the periodic payment amount 62″, is paid directly to the utility resource conservation agent 60″, or applicable successor in interest. For instance, a portion of the periodic payment amount 62″ for utility resource 30″, 32″ consumption could be paid directly to the applicable utility provider by the utility resource consumer, and the difference between the periodic payment amount and such utility payments could then be paid to the utility resource conservation agent. In the event that the utility payments result in a negative difference, that is, the utility payments exceed the periodic payment amount 62″, the utility conservation agent 60″ could then pay the difference to the utility resource consumer. Such payments would be properly considered as included in the periodic payment amount.

Also, the conditions of the periodic payment amount 62″ and the payment for use of the utility resource conservation devices 14″, 16″ and/or 50″-54″ included in the periodic payment amount 62″, are not necessarily limited to a particular type of property right conveyance. For instance, the conditions could include a lease agreement with a definite term, renewable or non-renewable, at the end of which term or terms, the utility resource conservation devices 14″, 16″ and 50″-54″ would be removed. The terms could also be a lease-to-own or mortgage-type transaction, at the end of which the utility resource conservation devices 14″, 16″ and 50″-54″ would be owned by the utility resource consumer. The term could also be variable. For instance, the term could vary based on the utility resource savings actually achieved and how quickly the utility resource conservation agent recoups its investment. Other arrangements are also possible, as will be appreciated by those skilled in the art.

Additionally, the utility conservation agent 60 can also transfer its entitlement to a future stream of periodic payment amounts 62 from the utility resource consumer 10 to a third party for a net present value. This transfer could be together with, or separate from, any obligations the utility resource agent 60 has to the utility resource consumer 10, utility providers, or any other related parties. To account for variability in the actual utility resource savings over time, for instance due to fluctuations in climate, degradation of utility resource conservation device performance, unexpectedly low utility pricing, or the like, a reserve amount can factored into each payment and reflected in the net present value. Further, the utility resource agent could sell any “green” credits on a commodities market, etc.

Furthermore, in the context of the present application, “without” utility resource conservation devices should not be understood as absolutely without any utility saving device, but rather as without any of the utility savings devices installed in connection with execution of the method of the present invention. For example, a utility resource consumer may already have installed fluorescent light bulbs in place of less efficient incandescent bulbs. In such an example, the periodic consumption value for utility resources by the utility consumer would be determined based on consumption with the fluorescent bulbs and not included in the determination of expected utility resource savings.

Also, FIGS. 5 and 6 illustrate advantageous examples of how the determinations illustrated in blocks 110, 112, 116 and 118 are made. However, the present invention is not necessarily limited to making the determinations according to these examples. The figures given in connection with these examples are intended for illustrative purposes, and not intended to reflect actual figures for corresponding values, amounts, percentages or the like, or limit the figures that can be set.

Additionally, the present invention is not necessarily limited to a particular method of the estimation of utility resource usage reduction shown in block 142. For example, the utility resource usage reduction associated with installation of high-efficiency HVAC or lighting could be estimated based on the difference in the published efficiencies of the previous HVAC or lighting and the high-efficiency models multiplied times the average monthly energy usage of the previous HVAC or lighting. Also, the utility resource usage reduction associated with a solar water heater or photovoltaic system could be estimated based on the average solar energy where the system is to be installed. The energy production of the heater or photovoltaic system for that amount of solar energy could then be determined, and that energy production subtracted from the energy that would otherwise have been required.

Furthermore, the present invention does not necessarily require the discount to be changed or increased after a given period (i.e., in accordance with a discount schedule). Alternately the discount could remain fixed, or could be changed as the result of some trigger, such as the repayment of the initial investment of the utility resource conservation agent 60.

Also, the present invention is not necessarily limited to conducting the re-determinations shown in blocks 116 and 118 after a pre-determined number of payments, nor is it necessarily required to re-determine every element. For instance, these re-determinations could be omitted altogether, or done repeatedly. Also, the re-determinations can be tied to a trigger, such as a change in utility rates or a change in utility resource consumption beyond what was previously determined, for example. To avoid excessive changes to the periodic payment amount, threshold values can be associated with the triggers. For example, a re-determination could be triggered by a change in the utility rates of greater than 5% of the utility rates at the time of the previous determination.

Other aspects and features will be further understood with reference to another example. A utility resource conservation agent 60 purchases a solar water heating system on behalf of a customer based upon a loan from a lender. The agent 60 arranges for the installation of the system for the customer with no up front cost to the customer. The customer continues to pay a fixed utility charge for hot water heating less a percentage of the savings over the period of the lease, and the percentage increases over time. The agent 60 gets paid either by being bought out by the loan, or by collecting the monthly payment from the customer and retaining whatever is left over after the loan payment.

In the present example, a hotel pays $1000/mo. in electricity costs for water heating. The agent 60 installs a solar water heating system which provides an estimated 60% savings in water heating costs (i.e., only $400 in electricity is required to heat the water for the hotel for a month, rather than the $1000 required before the system installation). The hotel now pays $400 for the electricity bill, plus the delta between the $400 and $1000 (i.e., $600) minus some percentage of the savings. A 10% savings is assumed for this example, so the hotel now pays $900 total, of which $400 goes to the electric company, and $500 goes to pay the loan payment. The $500 is calculated by subtracting $100 (10%*$1000) from the $600 delta.

At a certain point in the leasing period (e.g., 10 years), the savings rate increases (e.g., doubles). So, in the above example, the savings rate then goes to 20%, meaning the hotel now pays $600 minus (20%*$1000), or $400, rather than $500. In an alternative embodiment, a progressively increasing savings rate, e.g., 1% savings the first year, 2% in year two, 3% in year three, could be used. Other savings rate changes are also possible. At the end of the leasing period, the customer would own the system, never having paid more than they would otherwise have paid in electricity costs without the system (and, in fact, paying a lower monthly cost all along than would otherwise have been paid), although other ownership arrangements may be made, as discussed above.

To determine the savings rate for a given customer, a separate electric meter may be installed for solar water heating to determine the actual amount of electricity used, or this may be determined based upon a study of energy savings for a given period of time (e.g., a few months) vs. historic water heating costs. As electricity costs change from time to time, (e.g., the $400/mo. electric bill goes up to $500), an updated payment is also determined. For example, if the hotel is paying $500 after a 60% savings on its electric bill, without having the solar system installed it would otherwise be paying $1250 (i.e., $500/0.4). So, the hotel then pays a $500 electric bill, plus $750 (delta between $1250 and $500) minus $125 (10%*$1250). However, this number is still less than the electric bill that the customer would otherwise pay without the solar system.

Yet another advantageous feature of the leasing/financing method is that the systems may be purchased or installed on a “per building” basis, but then leased on a “per unit” (e.g., individual hotel room) basis. By way of example, a hotel may have 22 buildings consisting of 1,526 units. The agent 60 buys 22 systems and then leases the systems to the hotel based upon their 1,526 units.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A utility resource conservation method comprising:
determining a periodic consumption value for at least one utility resource by a utility consumer without use of at least one utility resource conservation device;
determining a periodic payment amount for the utility consumer with use of the at least one utility resource conservation device by applying a discount to the periodic consumption value so that the periodic payment amount is less than the periodic consumption value; and
installing the at least one conservation device to reduce consumption of the at least one utility resource by the utility consumer;
wherein the periodic payment amount includes payment for the reduced consumption of the at least one utility resource and for the at least one utility resource conservation device.

2. The method of claim 1 wherein the discount is based on an expected utility resource savings from use of the at least one utility resource conservation device.

3. The method of claim 2 wherein the expected utility resource savings includes an expected energy reduction credit.

4. The method of claim 2 wherein the expected utility resource savings includes a block energy purchase savings.

5. The method of claim 1 wherein the discount is fixed for a predetermined number of payments.

6. The method of claim 5 wherein the discount is increased after the predetermined number of payments.

7. The method of claim 1 wherein installation of the at least one utility resource conservation device is designed to provide an energy reduction credit threshold.

8. The method of claim 1 further comprising:
re-determining the periodic consumption value; and
re-determining the periodic payment amount by re-applying the discount to the re-determined periodic consumption value.

9. The method of claim 8 wherein the re-determinations are made after a predetermined number of payments.

10. The method of claim 1 wherein the periodic payment is fixed for a plurality of periods.

11. The method of claim 1 wherein the at least one utility resource comprises a plurality thereof.

12. The method of claim 1 wherein the at least one utility resource comprises at least one of electricity, natural gas, heating oil and water.

13. The method of claim 1 wherein the at least one utility resource conservation device comprises a plurality thereof.

14. The method of claim 1 wherein the at least one conservation device comprises at least one of a utility resource replacement device and a utility resource reduction device.

15. The method of claim 14 wherein the at least one utility resource replacement device comprises at least one of a solar water heater, a photovoltaic panel and a wind turbine.

16. The method of claim 14 wherein the at least one utility resource reduction device comprises at least one of an increased-efficiency lighting system, an increased-efficiency HVAC system, a water saving device and a utility use monitoring and control system.

17. An energy conservation method comprising:
determining a periodic energy consumption value by an energy consumer without use of at least one energy conservation device;
determining an expected energy savings from use of the at least one energy conservation device;
determining a discount based on the expected energy savings;
determining a periodic payment amount for the energy consumer with use of the at least one energy conservation device by applying the discount to the periodic energy consumption value so that the periodic payment amount is less than the periodic energy consumption value, the periodic payment amount including payment for the reduced energy consumption and for the at least one energy conservation device; and
installing the at least one energy conservation device to reduce consumption of energy by the energy consumer.

18. The method of claim 17 wherein the expected energy savings includes an expected energy reduction credit.

19. The method of claim 17 wherein the expected energy savings includes a block energy purchase savings.

20. The method of claim 17 wherein the at least one energy reduction device comprises at least one of an increased-efficiency lighting system, an increased-efficiency HVAC system, a solar water heater, a photovoltaic panel, and a utility use monitoring and control system.

21. A utility resource conservation method comprising:
determining a periodic consumption value for at least one utility resource by a utility consumer without use of at least one utility resource conservation device, the at least one utility resource conservation device comprising at least one utility resource replacement device;
determining a periodic payment amount for the utility consumer with use of the at least one utility resource conservation device by applying a discount to the periodic consumption value so that the periodic payment amount is less than the periodic consumption value; and
installing the at least one utility resource conservation device to reduce consumption of the at least one utility resource by the utility consumer;
wherein the periodic payment amount includes payment for the reduced consumption of the at least one utility resource and for the at least one utility resource conservation device.

22. The method of claim 21 wherein the at least one utility resource replacement device comprises at least one of a solar water heater, a photovoltaic panel and a wind turbine.

23. The method of claim 21 wherein the at least one utility resource device further comprises at least one utility resource reduction device.
